(19) United States
(12) Patent Application Publication
(10) Pub. No.: US 2002/0157106 A1
(43) Pub. Date: Oct. 24, 2002

(54) Cable channel search systems

(76) Inventors: Robert Uskali, Schaumburg, IL (US); William C. Hart, Schaumburg, IL (US)

Correspondence Address: MOTOROLA, INC., 1303 EAST ALGONQUIN ROAD, IL01/3RD, SCHAUMBURG, IL, 60196

(21) Appl. No.: 09/837,526

(22) Filed: Apr. 18, 2001

(51) Int. Cl. H04N 17/00; H04N 17/02

(52) U.S. Cl. 725/107; 348/192

(57) ABSTRACT

A receiver system for rapidly selecting a desired downstream receiver channel from the broad cable frequency bandwidth. The system first makes a coarse scan of the signal spectrum to identify the most probable frequency zones, and subsequently makes a high resolution scan of the selected frequency zones to identify the desired channel.

### FIELD OF THE INVENTION

The present invention relates generally to receiver systems for channelized networks, and more particularly, to methods and apparatus for selecting a desired channel where the channel plan of the channelized network is unknown.

### BACKGROUND OF THE INVENTION

Demand for high-speed Internet access has resulted in utilization of receivers such as cable modems to connect to broadband communications networks, such as cable television (CATV) systems, in various countries. The receiver must operate on broadband communications networks that deliver a multitude of services simultaneously. To keep these services from interfering with each other, the service provider allocates each service a distinct band of frequencies on the broadband network as a channel. A channel plan allocates the channels in the broadband frequency spectrum so that they do not interfere with each other.

Regulatory authorities in many countries and regions can, and do, regulate the channel plans of broadband communications networks. Further, even where differing regulatory authorities do not mandate different channel plans, because broadband communications services are typically using closed systems, broadband communications service providers have great flexibility in how they can allocate channels for their networks. The result is a worldwide multitude of channel plans.

Despite the use of a multitude of different channel plans, it is desirable for efficient and economical manufacture of receivers, to have only a minimal number of receiver designs. Such designs could be used throughout many of these countries and regions despite the differences in frequency allocation and utilization. In addition, it is desired that a limited number of receiver models be manufactured that would work optimally independent of the system in which it is used.

Channel plans define channel allocations by usually defining the center frequency and bandwidth of each channel, and may define the modulation type for the spectrum associated with the upstream and downstream communication signal path. Unfortunately, these cable channel frequency allocations and designs are different in different countries of the international market. For instance, some services do not require an upstream signal path at all

When receivers are first installed, when a receiver is moved, or when there are problems with a previously operating downstream channel the receiver must establish a new valid connection. Without a known channel plan, a receiver may spend an excessive amount of time (many minutes or more) finding the desired communication channel using conventional search algorithms. If a lengthy channel initialization is encountered, the end-user or installation technician must wait for this operation to complete before continuing with use of the receiver. In addition, with an excessive initialization delay, the user may perceive the receiver to be malfunctioning or inoperable.

For example, under Euro-DOCSIS, if a 91 MHz (megahertz, or million cycles per second) to 860 MHz downstream spectrum is to be searched using a brute force method when the channel plan and desired channel is not known, more than 3000 channel possibilities may have to be tested for the desired channel. The time necessary for the receiver to tune and its demodulator to accurately “lock” on the amplitude and phase of the signal is typically 300-1200 or more milliseconds (msec). For a 1000 msec Quadrature Amplitude Modulation (QAM) lock time, the time necessary for a conventional receiver to step through and lock on each possible frequency position in the broadband cable spectrum is significant, and can require up to a 50 minute initial search time for the receiver to find an internet connection channel.

Accordingly, there is a need for methods to enhance the channel scan initialization procedure in order to significantly reduce the time required to acquire the desired communication channel. Advantageously, such methods would enhance channel scan initialization procedures under both present and future channel plans.

### BRIEF DESCRIPTION OF THE DRAWINGS

FIGS. 1a-c illustrates a cable television (CATV) signal distribution system, FIG. 1a illustrates the signal transmission paths; FIG. 1b illustrates a typical distribution of the a signal spectrum in a CATV signal distribution system, and FIG. 1c illustrates some features of a channel in a CATV signal distribution system;

FIG. 2 is a block diagram of an example of a receiver that can be utilized for channel selection in accordance with the present invention;

FIG. 3 is a block diagram of an example of a dual conversion tuner that can be utilized as part of a receiver that can be utilized for channel selection in accordance with the present invention;

FIG. 4 illustrates a flowchart diagram of a spectral loading characterization process in accordance with a preferred embodiment of the present invention;

FIG. 5 illustrates how the combination of local oscillators, mixers and filters in a dual conversion tuner can be used to select a bandwidth of downstream signal;

FIG. 6a illustrates selected signal types that can be present in a downstream spectrum while FIG. 6b illustrates a possible constructed channel response of FIG. 6a;

FIG. 7 is a flowchart diagram of an example of a QAM channel check which may be used in a preferred embodiment of the present invention to; and

FIG. 8 illustrates another embodiment of an example of a method to identify a desired channel that uses a fast Fourier transform (FFT).

### DETAILED DESCRIPTION OF THE INVENTION

This invention provides receivers for broadband communications networks with improved channel search capabilities by evaluating the downstream input spectrum to identify the most probable frequency regions of the input spectrum that may contain desired channels when the overall channel plan or the region of a desired channel are not known.

A method of the present invention locates a desired downstream channel in a broad frequency spectrum input signal. This is done by generating a constructed channel response (also constructed spectrum response) from the broad frequency spectrum input signal. The constructed channel response is then processed to generate a list of prospective channels. The channels in the prospective channel list are then checked until a desired downstream channel is identified.

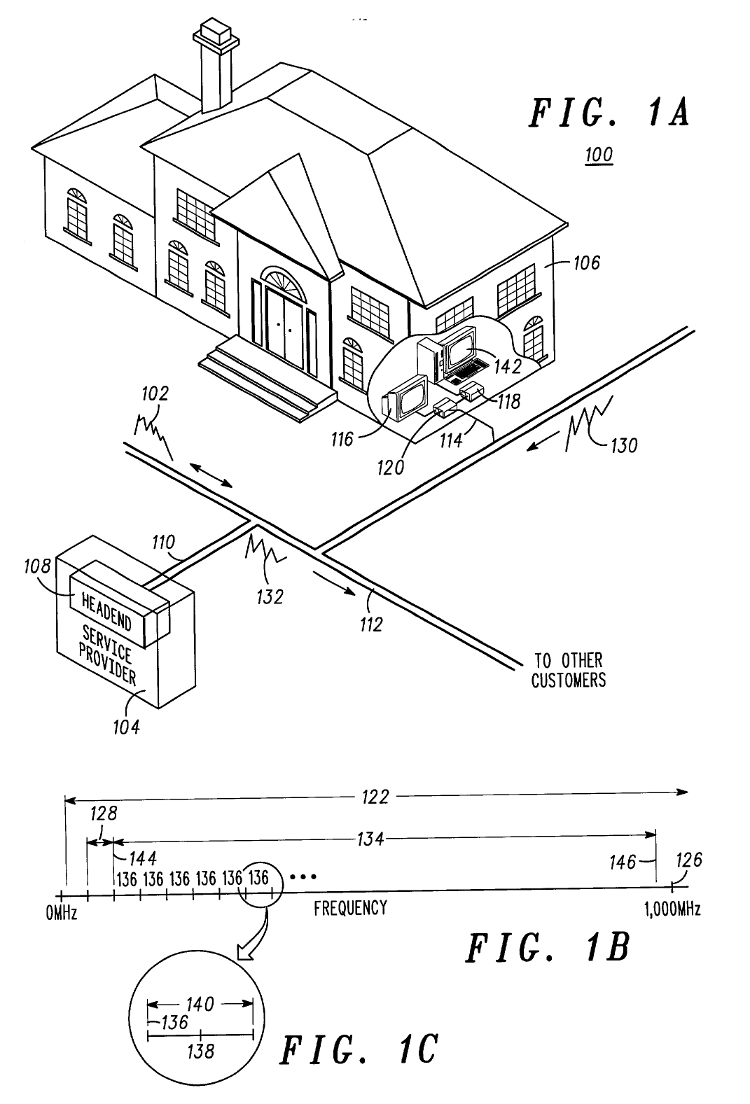

Referring to the FIGS. 1a-c, and particularly to FIG. 1a, a broadband communications network 100 transmits signals 102 between a broadband communications service provider (or “service provider” or “provider”) 104 and a customer 106. A common provider 104 of broadband communications networks 100 throughout the world are cable television companies, where the same cable transmits signals 102 for both television viewing and digital communications. For ease of explanation, the channels and the input spectrum are explained as part of a channelized cable television (CATV) system, but could be part of any channelized system.

The signals 102 from the service provider 104 to the customer 106 typically run from a headend 108 to a trunk line 110, and from a trunk line 110 to a distribution line 112. A drop line 114 typically connects the customer's 106 equipment (or hardware) to the distribution line 112. The customer may connect equipment such as a television 116, a receiver 118 such as a cable modem, set top box or telephony module to the drop line 114. Frequently a splitter 120 is used so that the customer 106 can connect both a television 116 and a receiver 118 to the drop line 114. The signals 102 from the customer to the service provider follow the opposite path. For simplicity of explanation, the different kinds of lines that can be present in the middle of the distribution chain between the headend 108 on the service provider's side, and the customer's 106 equipment (such as a television 116 or cable modem) on the customer's side 106 are generally omitted hereinafter.

The broadband communications network 100 will carry signals 102 in a frequency spectrum (or spectrum) 122. The spectrum 122 for a broadband network 100 typically has a frequency range from about 5 MHz or less at the lower end 124, to about 860 MHz presently, and possibly 1 GHz or more in the future at the upper end 126.

Referring in particular to FIGS. 1a-c, and in particular FIG. 1b, an “upstream” signal frequency portion of the spectrum (or upstream portion, or upstream spectrum) 128 is reserved for upstream signals 130 sent from the customer 106 to the service provider 104. Upstream signals 130 are transmitted from the customer's 106 equipment to the headend 108 in the upstream signal frequency portion 128 of the spectrum 122. The upstream signal frequency portion 128 of the spectrum is usually about 5-70 MHz, but can be at any frequencies carried by the network 100. The upstream signals 130 are typically both frequency and time division multiplexed to identify individual customers 106, but do not have to be. “Downstream” signals 132 from the service provider 104 are sent from its headend 108 to the customers 106, typically in a downstream frequency portion of the spectrum (or downstream portion or downstream spectrum) 134 at frequencies above about 70 MHz, but the frequencies used can be any frequencies carried by the network 100. The downstream spectrum 134 is typically divided into channels 136 of predetermined bandwidth, which in the United States are generally 6 MHz in width, and in Europe are generally 8 MHz in bandwidth. Referring to FIG. 1c, channels 136 are usually defined, conventionally, by the center of the frequency range included in the channel (called the center frequency or channel center) 138 and the size of the frequency spectrum dedicated to the channel (called channel bandwidth) 140. The present invention is not, however, limited to systems where all the channels 136 have the same channel bandwidth 140 or are designated by center frequencies 138.

The channels 136 in the downstream spectrum 134 can carry a variety of signals of various modulation types, e.g., 64 QAM, 256 QAM, vestigial sideband (VSB)-amplitude modulation (AM), 8 VSB, 16 VSB, orthogonal frequency division multiplexing OFDM) or any other channelized modulation format, including, but not limited to 64 or 256 QAM, cable television channels, QPSK and QAM communication channels.

This invention characterizes the downstream spectrum 134. Two embodiments are described in this disclosure, but the present invention can be present in a multitude of other embodiments, and the invention is not limited to the embodiments described herein. When the input spectrum characterization is complete, a detection algorithm is used to identify the desired downstream channel. An example of such a detection algorithm is a QAM detection algorithm used to detect QAM channels (the type of encoding used on cable modem networks currently), and the operation of the embodiments listed here are expressed in terms of detecting QAM channels, and channels on cable systems, but is not limited to such.

As illustrated in FIG. 1a, a receiver 118 is connected to the service provider's 104 headend 108 and the customer's 106 computer system 142. In a CATV system, the headend 108 and the receiver 118 are usually connected with a cable. For the cable any combination of coax, fiber, and fixed wireless links may be used, but typically fiber and coax both are used i.e. not just coaxial cable. The connection between the receiver 118 and the computer system 142 is via a variety of possible connections, but typically is a 10 base T or 100 base T Ethernet, firewire IEEE 1394, or USB connection. While those are the cablings typically used for such connections, the present invention can be used with other forms of wired or unwired networks 100 suitable for carrying a frequency spectrum 122 to a receiver 118, including but not limited to coaxial cabling, twisted pair wiring, fiber optic cabling, hybrid, coaxial/fiberoptic cabling, infrared transmitters, and over the air transmission such as with wireless LAN transmitters, and other systems known to those skilled in the art.

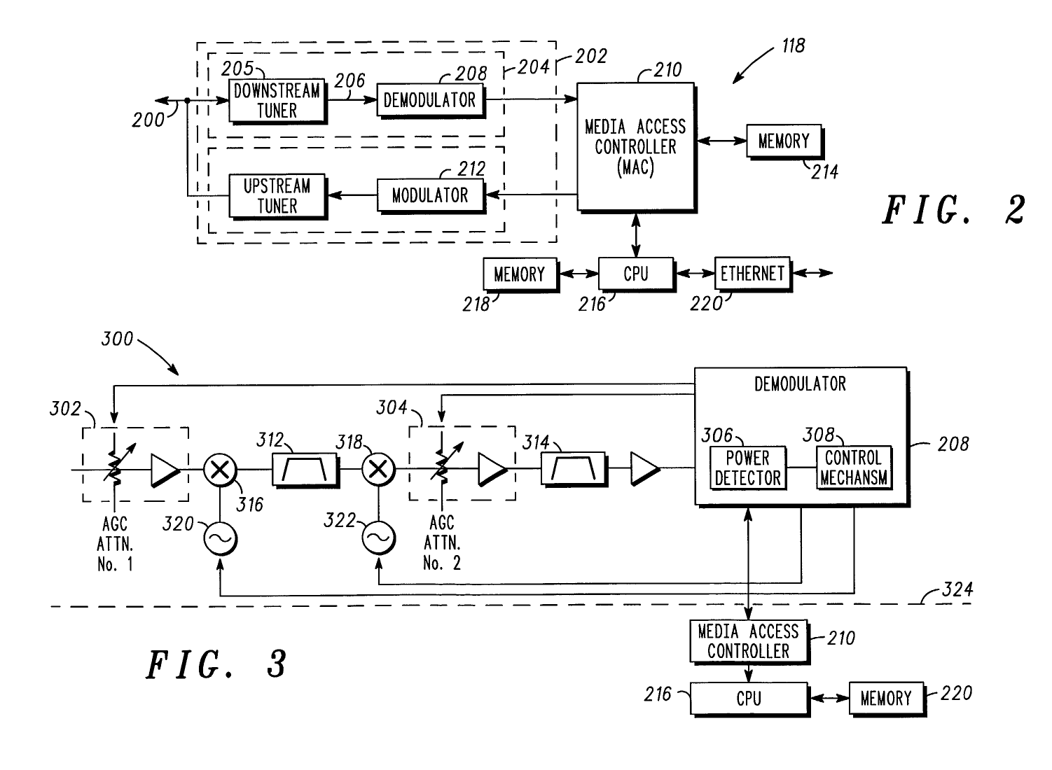

Illustrated in FIG. 2 is a block diagram useful in understanding some of the elements of a commercial receiver 118. A receiver 118 having hardware suitable for the practice of this invention is sold by Motorola Corporation under its trademark CyberSURFR. As is known to those skilled in the art, diagrams such as FIG. 2 serve to illustrate the functions of a piece of equipment, and do not necessarily represent how hardware is embodied to carry out the tasks. It will be apparent to those skilled in the art that the functionality of the present invention can be achieved with a variety of approaches and implemented in a number of substantially equivalent ways. The present invention is not limited to the particular implementations and embodiments disclosed.

The receiver 118 has a signal input 200. The signal input 200 conducts downstream signals 132 from the headend 108 to a physical layer 202, which has a downstream component called the downstream physical layer 204. The downstream physical layer comprises a downstream tuner 205 and a demodulator 208. The downstream physical layer 204 accepts downstream input signals 132 from the headend 108 and the downstream tuner 205 processes the downstream signals 132 before providing a tuned signal 206 to the demodulator 208. A media access controller (MAC) 210 connects the modulator 212 and the demodulator 208 to a first memory 214 and a central processing unit 216. The central processing unit 216 is connected to a second memory 218 and a host computer physical layer 220, which is typically an Ethernet layer. The host computer physical layer 220 sends signals to and receives signals from the host 142.

The downstream tuner 205 processes the downstream signal 132 before the tuned signal 206 is sent to the demodulator 208. The tuning that the downstream tuner 205 performs can include, but is not limited to, selecting a frequency range of signals to be sent to the demodulator 208, scaling the amplitude of the signals to make good use of the amplitude range of the demodulator 208, and shifting the frequency of the signals to occupy a frequency spectrum that the demodulator 208 operates well with.

Referring to FIG. 3, receivers 118 typically employ automatic gain control (AGC) systems in the downstream physical layer 204 to provide constant signal levels to the demodulator 208. FIG. 3 includes a dual conversion tuner suitable for the present invention, but those skilled in the art will appreciate that single or multiple conversion tuners can be used with the present invention. The downstream tuner 205 selects a fixed bandwidth of the downstream signals 132 to pass on as tuned signals 206, the width of the frequency range of the signals being passed on being the bandpass of the downstream physical tuner 205. Although present receivers currently use tuning electronics that select a fixed bandwidth, the present invention is not limited to such.

FIG. 3 illustrates a simplified block diagram of an example of a downstream physical layer 300 according to a preferred embodiment of the present invention. The illustrated downstream physical layer 300 has at least one variable gain device and preferably comprises at least two variable gain devices 302, 304, a power detector 306, a control mechanism 308 and is connected to a microprocessor (CPU) 216 via an media access controller (MAC) 210. Since the microprocessor 216 and MAC are not necessarily a part of the downstream physical layer, they are separated from the other components by a boundary line 324. These components can reside in the receiver 118 as discrete components or combined components with any other compatible component of the receiver 118. The variable gain devices 302, 304 may be attenuators or variable gain amplifiers

The downstream physical layer 300 illustrated in FIG. 3 operates as a dual conversion receiver that has a first filter 312 and a second filter 314, the first and second filters 312, 314 having respective associated tuning electronics, said respective associated tuning electronics being capable of being tuned independently of each other. The first and second filters 312, 314 are typically bandpass filters. In the illustrated embodiment, each filter 312, 314 is preceded by a respective mixer (first mixer and second mixer) 316 318 connected to a respective local oscillator (LO)(first local oscillator and second local oscillator) 320, 322 that shift the frequency of the downstream signal 132 to place a desired portion of the downstream stream signal within the bandpass of the respective filters 312, 314.

Usually, because of cost considerations, the first filter 312 has a bandpass that is substantially wider than the bandwidth allocated to the channels 140 on the broadband network 100. A bandpass of 30-40 MHz is typical for the first filter of dual conversion tuner on a receiver 118 such as the CyberSURFR modem. The second filter 314 preferably has a bandpass of about the same bandwidth as the bandwidth of the channels 136 allocated to services on the broadband network 100. The first and second filters 312, 314 in series have a combined bandpass that allows signals having frequencies in common with the two bandpasses to pass through. This combined bandpass is the bandwidth of the downstream tuner. If the channels 136 on the broadband network 100 vary in bandwidth, either the second filter 314 should be of adjustable width, or appropriate additional tuners should be supplied with the receiver. In the United States the bandpass of the second filter 312 is normally 6 MHz, and in Europe the bandpass is normally 8 MHz.

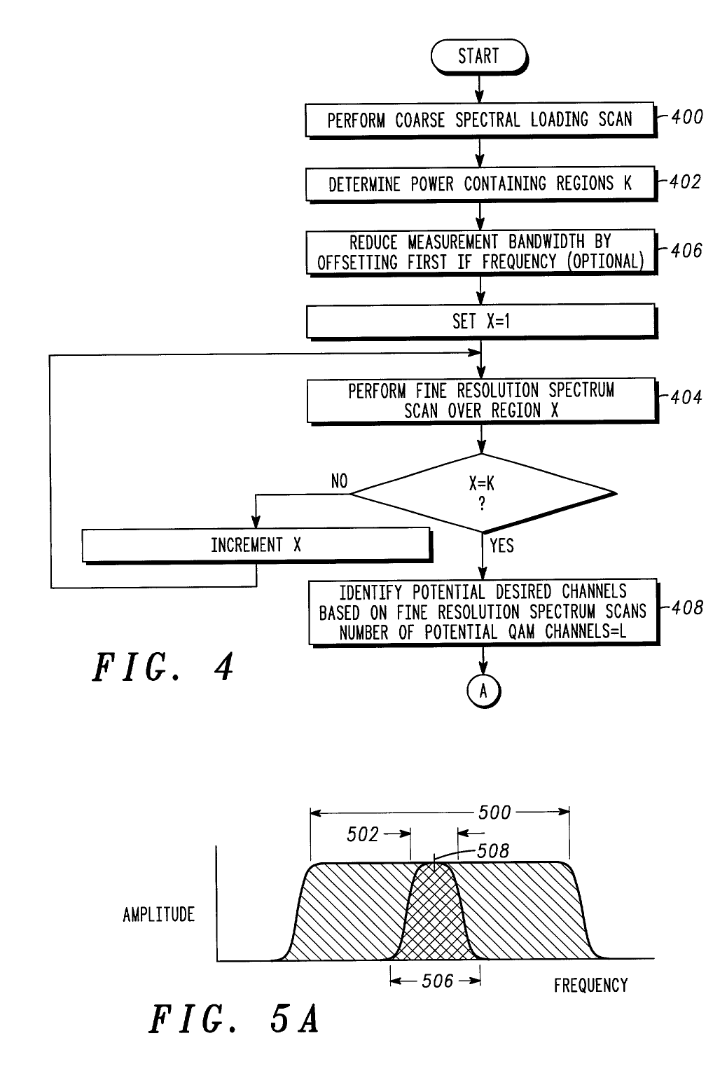

FIG. 4 is a flowchart that illustrates the first spectral loading characterization method. In this algorithm, a first, coarse spectral loading scan (also coarse spectral scan, coarse loading scan or coarse scan) 400 is performed. This is accomplished by tuning the downstream physical layer 204 to sample the ranges of interest of the input signal 132 between a desired lower spectrum limit 144 to a desired upper spectral limit 146. Currently, systems for which cable modems 118 are used would have a downstream spectrum 134 of about 50-1,000 MHz, but the invention will work with other downstream spectrum 134 ranges as well.

The coarse spectral loading scan 400 is preferably accomplished by defining a set of measurements to be taken that will measure the entire downstream spectrum 134 between the desired lower spectrum limit 144 and the desired upper spectrum limit 146. One approach is to begin at one end of the downstream frequency spectrum 134 and serially step at a relatively broad frequency increment up or down the downstream frequency spectrum 134 toward the other end of the spectrum 134. Preferably, the coarse frequency step size will be in the range of from about ½ the bandwidth of the downstream tuner (which, in a dual conversion tuner, may be a combined bandpass or more commonly, the bandwidth of the second filter), to about twice the bandwidth of the downstream tuner, and most preferably corresponding to the downstream tuner's bandwidth. For each measurement of the set of measurements, the channel power is measured and can be stored in memory 218.

The channel power can be measured using the power measurement capabilities of the receiver 118 that are standard in such receivers currently. In the embodiment illustrated in FIG. 3, the power detector (or detector) 306 and the control mechanism 308 reside in the demodulator 208, but may be located elsewhere in the receiver 118. The power detector 306 provides a means to measure the incoming signal level of the selected “coarse” or “fine” input frequency range to the detector 308 provided by the downstream physical layer 204. The power level is also used as part of a feedback variable gain control mechanism to set a desired signal level into the demodulator 208 as part of an automatic gain control (AGC) system 300.

It should be noted that the time required to measure channel power can be significantly less than the time required to determine whether a channel is a desired channel by other methods. In the case of a typical cable modem 118, the time to perform a QAM lock test is substantially longer than the time required to do a power measurement. A typical power measurement using present hardware can take about 6ms while a QAM lock test using current QAM lock circuitry can take about 1000 ms. This time difference provides significant improvement in channel search time in accordance with the present invention. The power measurement feature utilized in the present invention is typically included in conventional receivers 118 for other purposes such as diagnostics, network management, and automatic gain control feed back. To obtain the minimum time for channel power measurement, the receiver may be optimally configured for this purpose. For example, the AGC loop bandwidth may be increased for the channel power measurement. In a receiver 118 such as the CyberSURFR modem the AGC loop bandwidth can be set by a register contained within the demodulator's “AGC Control Mechanism.”

Another step in the first algorithm is to determine the power containing regions 402 of the downstream spectrum from the results of the coarse spectral loading scan 400. This is done by identifying a number of regions, K, where power above a threshold standard is detected. The set of measurements to detect power constitutes a power spectrum, and the frequency spectrum covered by the set of measurements where power is detected are power containing regions of the power spectrum, or power containing regions for short. Either the power spectrum, or just the power containing regions, can be recorded in digital memory, and can be processed to select potential frequency ranges for the desired channel. For example, this coarse scan may determine that based on a predetermined threshold, for instance, −15 dBmV, that no channels are present over one or more power lacking regions (regions not meeting the predetermined threshold) of the power spectrum (e.g., regions totaling, say, 550 MHz in a particular system). Ultimately, this information will reduce the search time for the desired downstream channel because these power lacking regions need not be searched.

Referring again to FIG. 4, another step in the first spectral characterization approach is a finer spectrum scan 404 which is performed over the at least the power containing regions. The finer spectrum scan 404 has a finer resolution, that is more data points over the same spectral regions as the coarse scan 400. While the finer spectrum scan can be done by performing measurements that have overlapping spectral ranges or by performing measurements that have narrower spectral ranges than the coarse scan or by performing scans that do both, the present invention can work with a wide variety of methods for taking a finer spectrum scan that will be apparent to those skilled in the art.

The bandwidth covered by a measurement can be reduced 406 (or narrowed) if a dual or multiple conversion tuner is being used. Reduction of the measurement bandwidth in a dual or multi conversion tuner can be easily accomplished without added circuitry in the unique manner as described below. However, this does not mean that such measurement bandwidth narrowing is exclusive to dual/multi tuners. It can be accomplished in a single conversion tuner by switching in a narrow bandwidth filter in place of filter 314, by switching in an additional bandpass filter, limiting amp 304 bandwidth, or by other methods known to those skilled in the art.

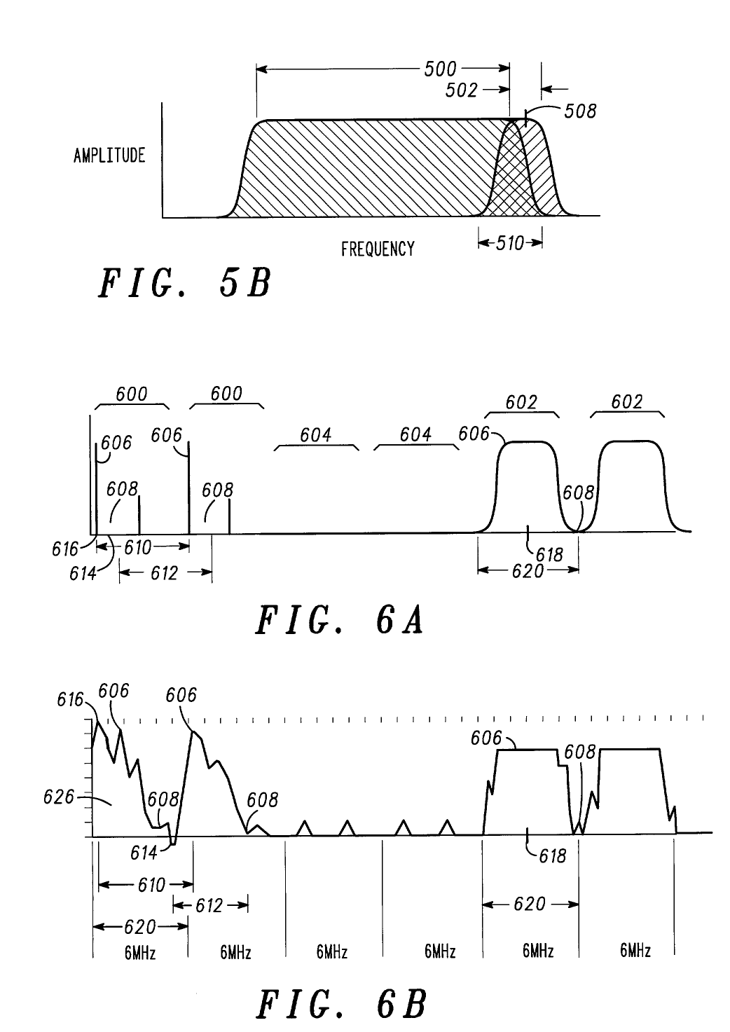

As described above, such tuners have at least a first filter 312 and second filter 314 that can be used in an unconventional way to narrow the frequency range for a signal power measurement. As illustrated in FIG. 5a, the mixers 316, 318 and respective local oscillators 320, 322, cooperate such that the signal frequencies passing through the second filter 502 are normally located entirely within the signal frequencies passing through the first filter 500 resulting in a first net bandpass 506 such that an entire channel's signal passes through both filters. Alternatively, as illustrated in FIG. 5b, however, the frequencies passed through the pair of filters 312, 314 can be reduced by having the oscillators 316, 318 and mixers 320, 322 positioning the center of the bandpass 508 of the second filter 314 at the “edge” of the bandpass of the first filter 312. The resultant second net bandpass 510 is narrower than the bandpass of either filter. Usually, this is accomplished by offsetting the second local oscillator frequency from its normal value. Although more precise results may be obtained with this offset technique, it is not required by this invention.

Returning to FIG. 4, with or without the bandwidth reduction or narrowing, a fine spectral loading scan (or fine scan) 404 can be performed by scanning the power containing regions at a finer frequency increment than the original course scan increment. The downstream physical layer 204 is methodically tuned to each test frequency range where the input power is measured and stored in memory.

For example, for a European DOCSIS cable system, the coarse scan 400 may be performed with 8 MHz intervals to determine power containing spectral regions 402 with power containing or power lacking channels. In another step, a higher frequency resolution (fine or relatively finer or finer resolution) scan 404 can be performed using a smaller frequency interval, which is less than one half, the frequency interval of the coarse scan, for example, about 2 MHz. In each case, channel power is measured and stored in memory for each measurement of the set of measurements. The set of measurements is a constructed channel response.

After the power levels of the power containing spectral regions have been quantified by the fine scan 404, potential desired channels are identified via an off-line processing operation 408. The input spectrum characterization may be performed by the microprocessor 216. Referring to FIG. 6, this offline processing operation 408 “views” the constructed channel response obtained during the fine resolution scan to identify features such as NTSC video carriers 600, QAM signals 602, and voids 604.

By using pattern matching techniques, a large variety of which are known in the art, channel content can be tentatively identified without actually having to establish a lock on the signal. The offline processing operation 408 characterizes the constructed channel response. One way of conducting the offline processing operation determines the signal type, bandwidth, and center frequency, but many different techniques may be derived for this purpose. For example, a simple approach in determining the center frequency and bandwidth of the incoming signal involves an analysis of the minimum (“valley”) and maximum (“peaks”) values of the constructed spectrum response.

Referring to FIGS. 6a-b, it can be seen that peaks 606 and valleys 608 are present. By cataloging these peaks 606 and valleys 608, and calculating the frequency differences between peaks 610 as well as the frequency differences between valleys 612, it can be surmised that it is quite likely that 6 MHz bandwidth signals are present. In addition, the absolute frequency of the valleys 614 or peaks 616 give indications to the actual center frequency 618 of the measured channel 620. Further analysis of the constructed spectrum response can give indications of the signal type.

For example, as can be seen in FIGS. 6a-b, a downstream QAM signal 602 compared to a NTSC analog video signal 600 has a much more uniform amplitude response. In the example of FIG. 6b, the shape of the constructed signal within one 6 MHz wide region 618 defined by two valleys 614 tends to have an asymmetrical peaking response with more spectral energy in the leftmost area 626 of the assumed channel. It can be surmised that this response shape was generated from the corresponding analog video NTSC signal shown above it in FIG. 6a.

In order to enable signal type determination, pattern matching and correction techniques are used. For example, a simple shape mask could be used to sort NTSC signals 600 from QAM signals 602. A mask for each signal type must first be created representing the typical spectral properties of each signal. Next, the constructed spectrum response is divided into prospective channels by methods as previously described (including, but limited to peak and valley analysis). Each constructed channel response can be normalized to aid in comparison to the predefined signal mask. At this point, one of any number of standard or custom defined correlation methods known to those skilled in the art can be applied. Correlation to each mask is correlation operation, a determination of the recovered signal type can be made based on the correlation results.

As a result of the pattern matching technique above, a list of prospective desired channels is generated. Preferably, this list is generated by identifying the center frequencies and bandwidths of the channels 136. The number of prospective channels in this list can be very small compared to the total number of possible channels (5-100, versus 3000, for example) for the desired channel's signal. With a channel power measurement time of 6 msec, all power measurements required in the algorithm of FIG. 4 may be performed in less than 2 seconds.

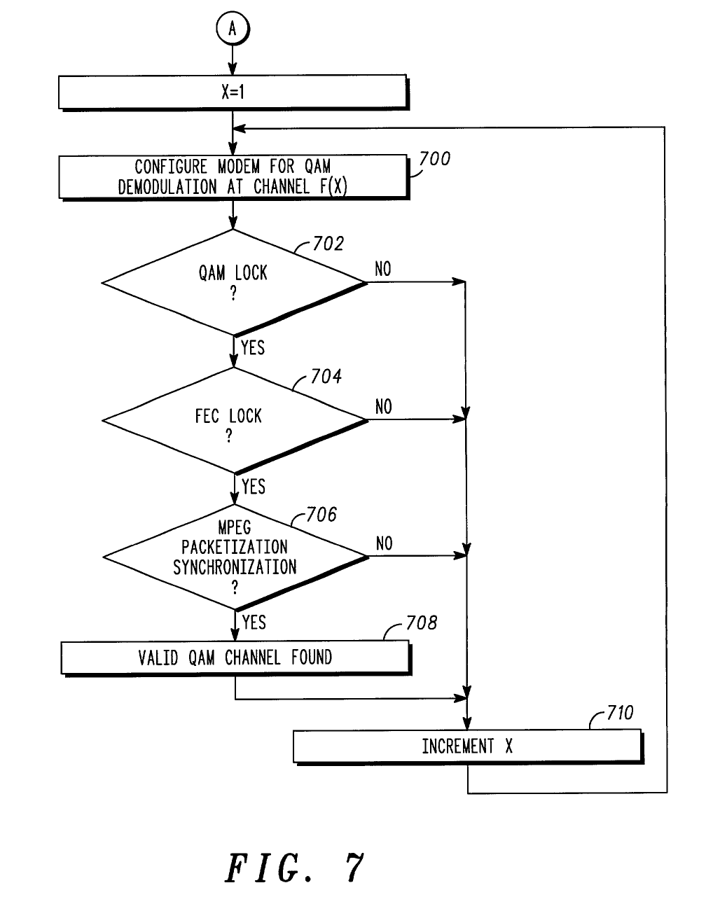

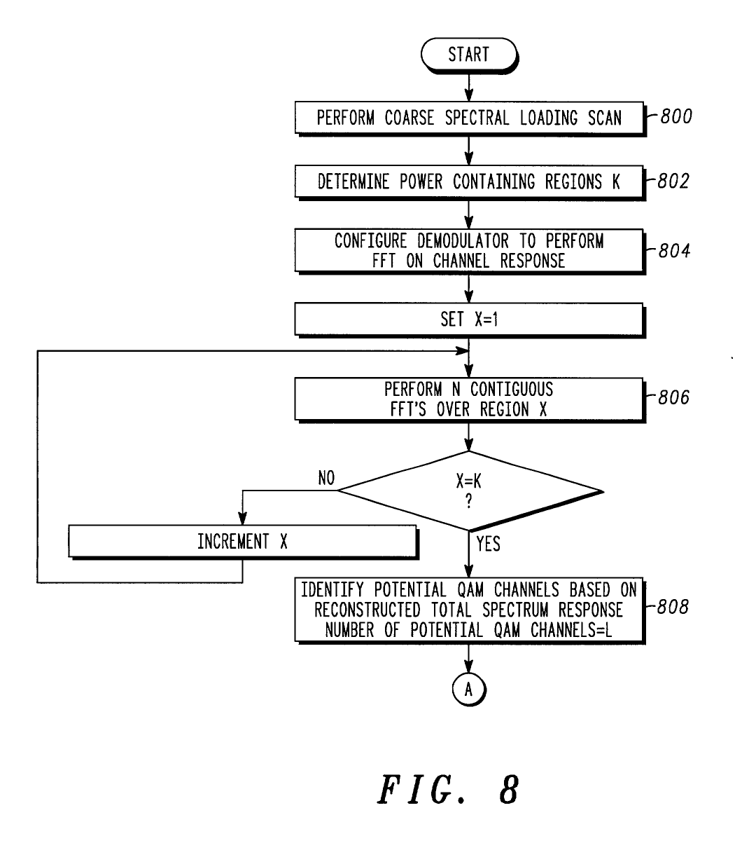

FIG. 7 illustrates a standard channel check algorithm that can be performed on each of the prospective desired channels until the desired downstream channel is located. For purposes of illustration, a QAM check algorithm has been illustrated because QAM encoding is the type used for cable modems. The invention is not, however, limited to QAM encoding. A prospective channel is selected and the downstream physical layer 204 is configured 700 to present that channel's tuned signal 206 to the demodulator 208. In another step, the receiver 118, usually through its demodulator 208, checks if it can lock on to the desired channel 702. If it can, then the receiver 118, usually through its media access controller 210, can check for a forward error correction (FEC) lock 704. Further, the can check for MPEG packetization synchronization 706. In another step, the receiver, usually through its media access controller, checks for recognized downstream MAC SYN messages, and if such messages are found, identifies the channel as a valid QAM channel. If the channel is valid, then procedures appropriate to having found a valid QAM channel are performed 708 which will depend on the system (with or without termination of the search), or if the channel was not a valid QAM channel, the next prospective channel in the list is checked 710.

FIG. 8 is a flowchart of an alternate QAM identification method that can be used in place of the method of FIG. 4. As in the method of FIG. 4, the same coarse spectral loading characterization 800 can be performed. The amount of processing required in the later steps of this procedure can be reduced by determining the power containing regions of the spectrum 802. The receiver can then be configured 804 to perform a spectral analysis operation, preferably, as illustrated, a fast Fourier transform (FFT). The spectral analysis operation would usually be performed in the demodulator. Thereafter, for each power containing spectral region, a constructed channel response is determined by means of a spectrum analysis operation 806 performed by the receiver, usually in the demodulator. Although the FFT method is illustrated and preferred, other spectrum analysis methods will be apparent to those skilled in the art and are also part of the present invention.

After each of the power containing spectral regions are characterized as described above, a more complete spectral response of the power containing regions of the spectrum can be constructed 808 by combining the individual spectrum analyses to make up a larger response. Reference amplitudes of the spectral analysis responses can be determined by the power measurements made in the coarse spectral scan operation. These reference amplitudes can be used to calibrate the spectral analyses so that adjacent spectrum analyses can be combined to form larger spectrum analyses. Preferably, all adjacent power containing regions are combined to construct contiguous power containing regions.

Although these spectral analyses are performed on contiguous, non-overlapping portions of the downstream spectrum, the measurements can also be performed by overlapping the regions covered by individual spectrum analysis operations. When the spectral analyses overlap in the downstream spectrum, the overlapping portions can be used to scale the regions relative to one another to calibrate the entire spectrum as will be apparent to those skilled in the art.

Within the fully constructed power containing portion of the spectrum, prospective desired channels are identified and a list of these channel centers and bandwidths is generated, and may be stored in the microprocessor memory. Optionally, the shape of the spectrum of channels identified as desired channels can be analyzed to determine if the prospective desired channel has the width and shape of the desired channel, and unsuitable channels removed from the list.

Like the process in FIG. 4 408, after the channel power spectrum characterization data is collected, it is interpreted by an algorithm (preferably implemented via a microprocessor) with embedded software that in turn identifies prospective cable channel frequencies for selective testing for specific desired channel identification. The algorithm identifies potential desired channels (in the illustrated embodiment, QAM channels) based on analyzing the reconstructed total spectrum response 808.

### EXAMPLES

### Example 1

### Analysis By Fine Increment Power Scan

The broadband network provides a downstream signal in the downstream frequency spectrum of 46 MHz to 854 MHz. Within that downstream signal, at an unknown frequency, is a 64 QAM channel used for digital communication. The broadband network is connected to a receiver. The desired channel is a 64 QAM channel with a bandwidth of 8 MHz centered at 710 MHz.

The receiver can perform a coarse spectral loading scan by measuring the downstream frequency spectrum beginning with a series of power measurements that measure a bandwidth of 8 MHz each. A power detector in the receiver performs the power measurements. The first measurement can have a bandwidth of 8 MHz and a center at 50 MHz, and cover the spectrum from 46 MHz to 54 MHz. Successive measurements will have bandwidths of 8 MHz and centers with increments 8 MHz higher than the previous measurement. The one hundredth measurement will have a center at 850 MHz and cover the spectrum from 846 MHz to 854 MHz. The power measurements can be stored in memory.

A microprocessor can then determine whether the power measurements stored in memory surpass a power threshold of −15 dBmV. The microprocessor then identifies contiguous regions containing power. For the purposes of this example, the regions from 46-454 MHz, 606-694 MHz, and 706-714 MHz are found to contain power.

The receiver then scans the first power containing region at a bandwidth of 8 MHz, with an increment of 2 MHz. The first measurement will be centered at 40 MHz, the second at 56 MHz, and so on until the last measurement is centered at 460 MHz. An offline processing operation will then examine the result of the finer incremented power scan to identify regions where a 64 QAM channel can be found and generate a list of possible desired channel frequency centers and bandwidths. No possible channels are found.

The receiver then scans the second power containing region at a bandwidth of 8 MHz, with an increment of 2 MHz. The first measurement of the second set will be centered at 600 MHz, the second at 602 MHz until the last is centered at 700 MHz. An offline processing operation again examines the results to see if the shape of the power measurements could be consistent with a 64 QAM channel. The offline processing operation identifies three possible 64 QAM channels centered at 674 MHz, 682 MHz, and 690 MHz.

The receiver then scans the third power containing region at a bandwidth of 8 MHz starting at 700 MHz and running to 720 MHz in increments of 2 MHz. The ensuing offline processing operation identifies the channel as a possible QAM channel.

A 64 QAM check algorithm is then performed. The downstream physical layer is configured to receive an 8 MHz wide channel at 674.5 MHz. The demodulator then attempts to establish a QAM lock, that is, whether it can identify signals located at the proper patterns of amplitude and phase for that kind of signal. The lock fails.

A 64 QAM check algorithm is also attempted on the channel at 682.5 MHz, and succeeds. The demodulator of the receiver then tries to establish a forward error correction (FEC) lock. The lock fails.

A 64 QAM check algorithm is then attempted on the channel at 690.5 MHz, and succeeds, and the FEC lock also succeeds. The demodulator checks for MPEG packetization synchronization and fails.

A 64 QAM check algorithm is then attempted on the channel at 710.5 MHz. The QAM lock, FEC lock, and MPEG packetization synchronization all succeed. The media access controller checks for MAC SYN messages. When the media access controller recognizes a MAC SYN message, the channel at 710.5 MHz is identified as valid, and the desired channel has been found.

### Example 2

### Analysis By Fine Increment Power Scan In 250 kHz Steps

To better identify each potential QAM channel's center, the search is done as in Example 1, except that the local oscillators of the downstream tuner are set so that only 250 kHz of downstream signal passes through both filters. Then each of the prospective channels at 674, 682, 690 and 710 MHz is scanned in steps of 250 kHz. The finer scan finds that the shape of the channel at 674 MHz is not as consistent with 64 QAM as the others and that channel is placed at the end of the prospective channel list. The number of potential QAM channels (L) is 4. Optionally, the channel at 674 MHz could just as easily be deleted from the prospective channel list, reducing L to 3.

### Example 3

### Analysis by Fast Fourier Transform

Alternatively, the receiver can be provided with firmware or hardware fast Fourier transform (FFT) capability. To better identify each potential QAM channel's center and the shape of each signal, the search is done as in Example 1, except that the local oscillators of the downstream tuner are set so that the full bandwidth of the downstream tuner passes through. A fast Fourier transform is then performed on the signal received. The downstream tuner is then set to select another section of the downstream signal and another fast Fourier transform is performed on that section of the downstream signal. This is done for the full spectrum of interest, with the separate scans being scaled by the results of the coarse power scan measurements. These scaled results are combined to provide a complete picture of the power-containing portions of the downstream spectrum. This results in an even finer resolution than even the 250 KHz bandwidth power scan, and finds that the shape of the channel at 674 MHz is not consistent with 64 QAM and deletes it from the prospective channel list, reducing L to 3.

### Example 4

### Analysis by Fast Fourier Transform with Alternative Scaling

The fast Fourier channel scan of Example 3 can be performed by overlapping the scans by ¼ of the bandwidth of the downstream tuner. The overlapping sections can be compared and scaled against each other to provide a complete picture of the power containing portions of the downstream spectrum.

While the invention has been described in conjunction with a specific embodiment thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. A method for locating a desired channel in a downstream signal comprising the steps of:
scanning the downstream signal to generate a constructed channel response;
processing the constructed channel response to generate a prospective channel list; and
checking the prospective channel list to find the desired channel.

2. The method of claim 1 comprising in addition the step of scanning the downstream signal with a coarse power spectrum scan to identify power containing regions of the downstream signal, wherein the step of scanning the downstream signal scans the power containing regions.

3. A method in accordance with claim 1 wherein the coarse power spectrum scan has an increment that corresponds to a downstream physical layer bandwidth of about 6-8 MHz.

4. A method in accordance with claim 1 wherein scanning the downstream signal comprises a relatively finer bandwidth power spectrum scan.

5. A method in accordance with claim 1 wherein scanning the downstream signal comprises a relatively finer increment power spectrum scan.

6. A method in accordance with claim 1 wherein scanning the downstream signal comprises performing at least one spectrum analysis operation.

7. A method in accordance with claim 5, wherein the spectrum analysis operation comprises a fast Fourier transform.

8. A method in accordance with claim 1, wherein the prospective channel list is checked with a QAM lock algorithm.

9. A method for locating a desired channel in a downstream signal comprising the steps of:
identifying power containing regions of the downstream signal with a relatively coarse power spectrum scan wherein each step of the scan covers about a 6-8 MHz portion of the downstream signal;
performing a relatively finer power spectrum scan on the power containing regions of the downstream signal to generate a constructed channel response of the power containing regions;
processing the constructed channel response of the power containing regions to generate a prospective channel list; and
checking the prospective channel list with a QAM lock algorithm until the desired channel is identified.

10. A method for locating a desired channel in a downstream signal comprising the steps of:
identifying power containing regions of the downstream signal with a relatively coarse power spectrum scan wherein each step of the scan covers about a 6-8 MHz portion of the downstream signal;
performing a Fourier analysis on the power containing regions of the downstream signal to generate a constructed channel response of the power containing regions; processing the constructed channel response of the power containing regions to generate a prospective channel list; and
checking the prospective channel list with a QAM lock algorithm until the desired channel is identified.
